(19) United States
(12) Patent Application Publication
(10) Pub. No.: US 2006/0032059 A1
(43) Pub. Date: Feb. 16, 2006

(54) Hunting knife with rifle stock handle

(76) Inventor: John R. Corwin, Grand Rapids, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/916,189

(22) Filed: Aug. 11, 2004

(51) Int. Cl. B25B 3/00

(52) U.S. Cl. 30/340

(57) ABSTRACT

A hunting knife comprising an elongated blade and attached handle formed in the shape of a trigger hand portion and a shoulder engaging portion of a rifle stock. The portion of the handle representing the trigger hand portion of the rifle stock serves as a forefinger portion of the handle and is shaped so as to comfortably engage a forefinger of the person holding the hunting knife. The portion of the handle representing the shoulder engaging portion of the rifle stock serves as a hand gripping portion of the handle and is shaped to comfortably engage the hand and fingers other than the forefinger of the person holding the hunting knife. The handle is shaped to restrain the hand from slipping forwardly or rearwardly on the handle.

### CROSS-REFERENCES TO RELATED APPLICATIONS

This is a non-provisional application based on and claiming the filing priority of co-pending design patent application Ser. No. 29/188,008, filed Aug. 11, 2003, which is incorporated by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates generally to knives comprising an elongated blade and attached handle. In particular, the invention relates to a hunting knife having a handle formed in the shape of trigger hand engaging portion and a shoulder engaging portion of a rifle stock.

2. Description of Related Art

Conventional hunting knives are well known. The relevant art of interest describes various knives, but, none disclose the present invention. An object of the present invention is to provide a hunting knife with a handle shaped in the form of a rifle stock handle, wherein the handle is formed to secure one's grip on the knife to facilitate the use of cutting surface of the knife without slippage or injury.

### SUMMARY OF INVENTION

In attainment of the foregoing objects, a preferred embodiment of this invention contemplates a hunting knife comprising an elongated blade and attached handle, with the handle being formed in the shape of a trigger hand portion and shoulder engaging portion of a rifle stock. The shoulder engaging portion extends from the trigger hand portion to the butt or end of the rifle stock. The portion of the handle representing the trigger hand portion of the rifle stock serves as a forefinger portion of the handle and is shaped so as to comfortably engage a forefinger of the person holding the hunting knife. The portion of the handle representing the shoulder engaging portion of the rifle stock serves as the hand gripping portion of the handle and is shaped to comfortably engage the hand and fingers other than the forefinger of the person holding the hunting knife.

Advantageously, the formation of the handle in the shape of a portion of a rifle stock creates a hunting knife that secures one's grip on the hunting knife to utilize the cutting surface of the knife and prevent slippage and injury.

These and other features, objects, and benefits of the invention will be recognized by one having ordinary skill in the art and by those who practice the invention, from the specification, the claims, and the drawing figures.

### BRIEF DESCRIPTION OF DRAWINGS

The invention will now be described with reference to the drawings wherein:

FIG. 1 is a top right perspective view with a rifle stock handle showing the design looking from the sharpened tip to the butt;

FIG. 2 is a bottom right perspective view looking from the butt to the sharpened tip;

FIG. 3 is a right side elevational view showing an increasing taper from the handle to the butt;

FIG. 4 is a top plan view showing a waist portion between the handle and the butt.

FIG. 5 is a left side elevational view showing an increasing taper from the handle to the butt;

FIG. 6 is a bottom plan view showing a waist portion between the handle and the butt;

FIG. 7 is a tip and elevational view thereof;

FIG. 8 is a butt and elevational view;

FIG. 9 is a top left perspective view with a rifle stock handle showing the design looking from the sharpened tip to the butt;

FIG. 10 is a right perspective view looking from the tip to the butt;

FIG. 11 is a bottom left perspective view looking from stock handle showing the design looking from the sharpened tip to the butt;

FIG. 12 is a bottom right perspective view looking from the butt to the sharpened tip;

FIG. 13 is a right side elevational view showing an the butt to the sharpened tip;

FIG. 14 is a top plan view showing a waist portion between increasing taper from the handle to the butt;

FIG. 15 is a left side elevational view showing an increasing taper from the handle to the butt;

FIG. 16 is a bottom plan view showing a waist portion between the handle and the butt;

FIG. 17 is a sharpened tip and elevational view thereof; and

FIG. 18 is a butt and elevational view.

### DETAILED DESCRIPTION

A preferred embodiment of a hunting knife with rifle stock handle according to the invention is generally shown in the drawing figures and discussed below.

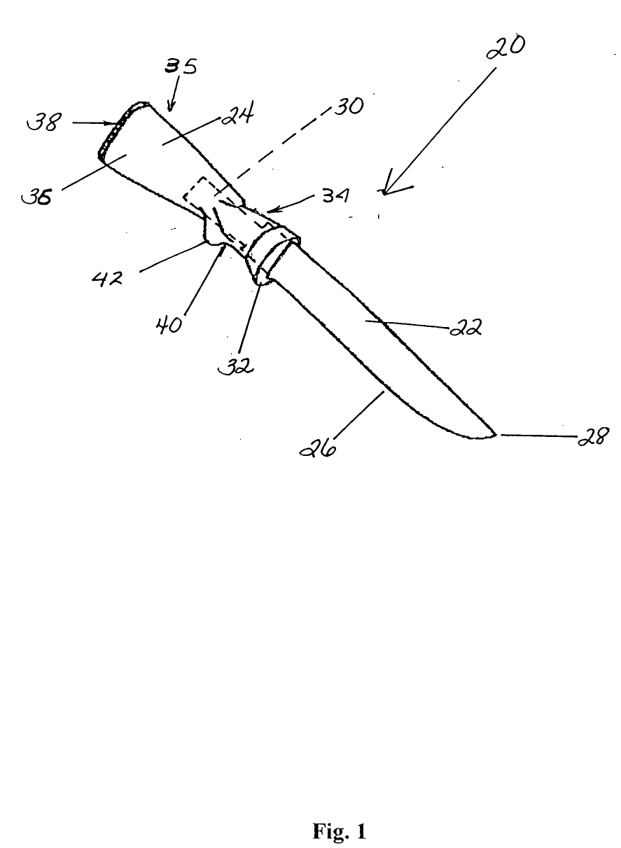

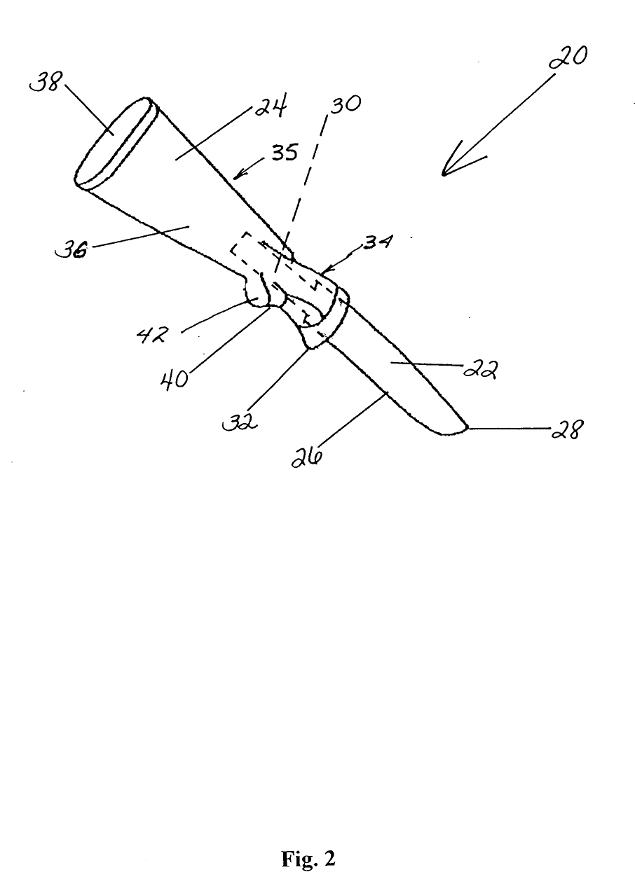

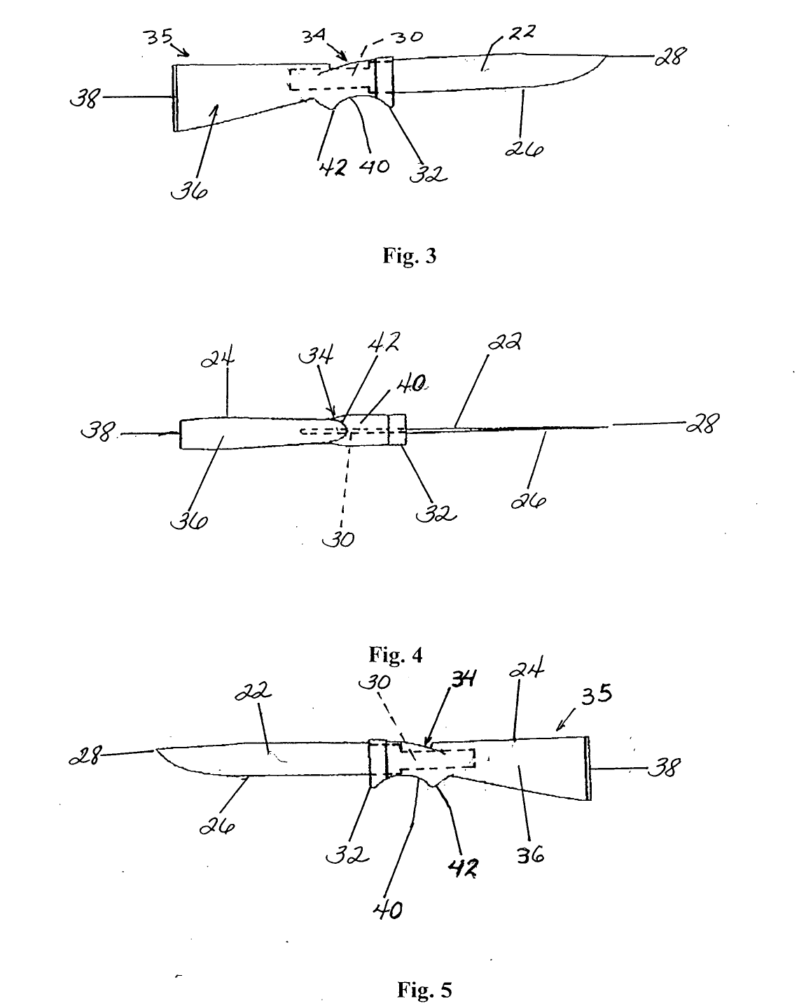

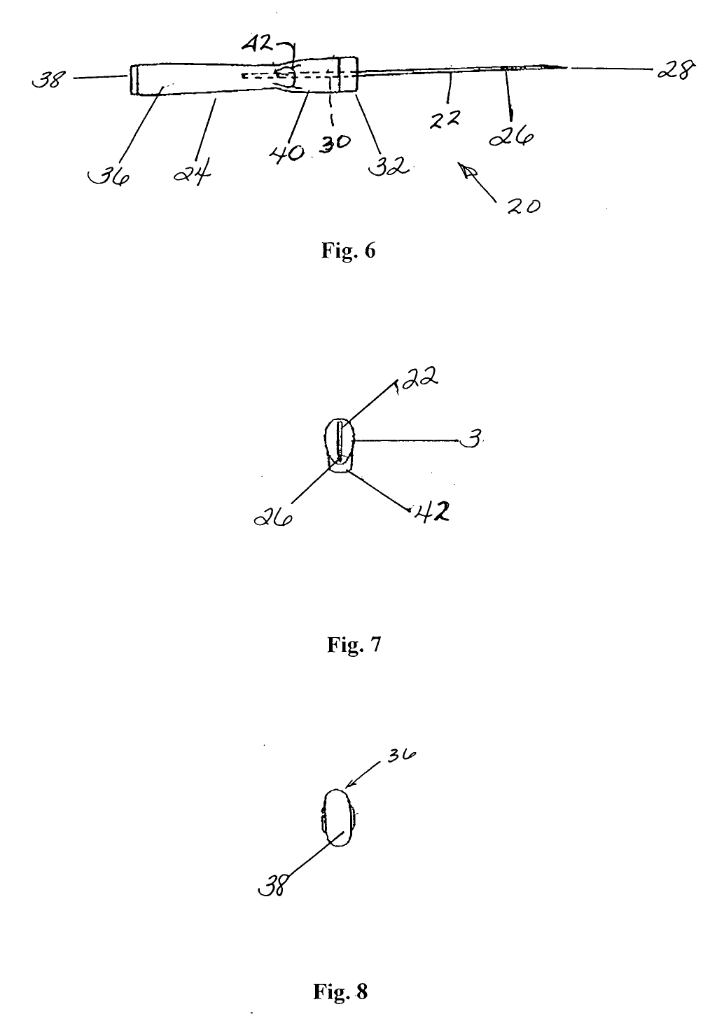

FIGS. 1-8 illustrate by different views a hunting knife 20 comprising an elongated blade 22 and attached handle 24, the elongated blade 22 having a longitudinal axis. The elongated blade 22 includes a sharpened edge 26 along a longitudinal side and a sharpened tip 28 at an outer end and a handle mounting portion 30 at an inner end. The handle 24 is mounted on the handle mounting portion 30 and secured by a collar 32. The handle 24 is formed in the shape of a portion of a rifle stock, the handle 24 having a generally straight longitudinal axis that is generally parallel to the axis of the elongated blade 22. The portion of the rifle stock represented in the handle 24 includes a trigger hand portion 34 and a shoulder engaging portion 35. The shoulder engaging portion 35 extends from the trigger hand portion 34 to a butt 38 of the handle 24. The portion of the handle 24 representing the trigger hand portion 34 of the rifle stock serves as a forefinger portion 40 of the handle 24 and is shaped so as to comfortably engage a forefinger of a person holding the hunting knife 20. The portion of the handle 24 representing the shoulder engaging portion 35 of the rifle stock is a hand gripping portion 36 of the handle and is shaped to comfortably engage the hand and fingers other than the forefinger of the person holding the hunting knife 20. The longitudinal orientation of the elongated blade 22 with respect to the longitudinal orientation of the handle 24 causes the sharpened tip 28 of the elongated blade 22 to face generally laterally from the hand of the person holding the hunting knife 20 when the handle 24 is held in a fist-like gripping action, such that the elongated blade 22 can be applied in a cutting action by a forward or backward thrust of the arm of the person holding the hunting knife 20.

Desirably, the forefinger portion 40 of the handle 24 is curved gradually downwardly for a distance sufficient to accommodate a typical male forefinger, the hand gripping portion 36 extending rearwardly from the forefinger portion 40 and having a generally oval shape that is sufficiently large to present a comfortable hand grip. The hand gripping portion 36 flares laterally outwardly toward the butt 38 of the handle 24 so as to restrain the hand of the user from slipping off the butt 38 of the handle 24.

The handle 24 includes a laterally protruding projection 42 at the junction between the forefinger portion 40 and the hand gripping portion 36, such that the hand gripping portion 36 engages the laterally protruding projection 42 and is restrained from sliding forwardly on the handle 24 toward the sharpened edge 26 of the elongated blade 22 when the hunting knife 20 is forced forwardly against a resisting force. The laterally protruding projection 42 is formed by a rear outer end of the forefinger portion 40 of the handle 24, the laterally protruding projection 42 being formed in the shape of the bottom of the trigger hand portion 34 of the handle 24 adjacent where the trigger hand portion 34 joins the shoulder engaging portion 36.

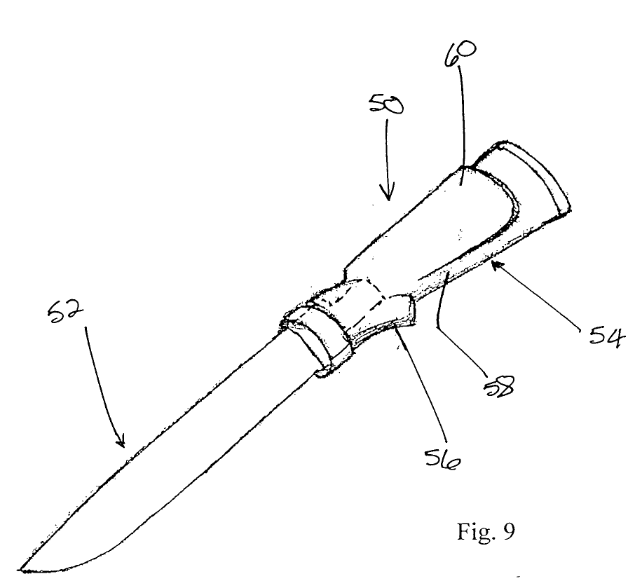

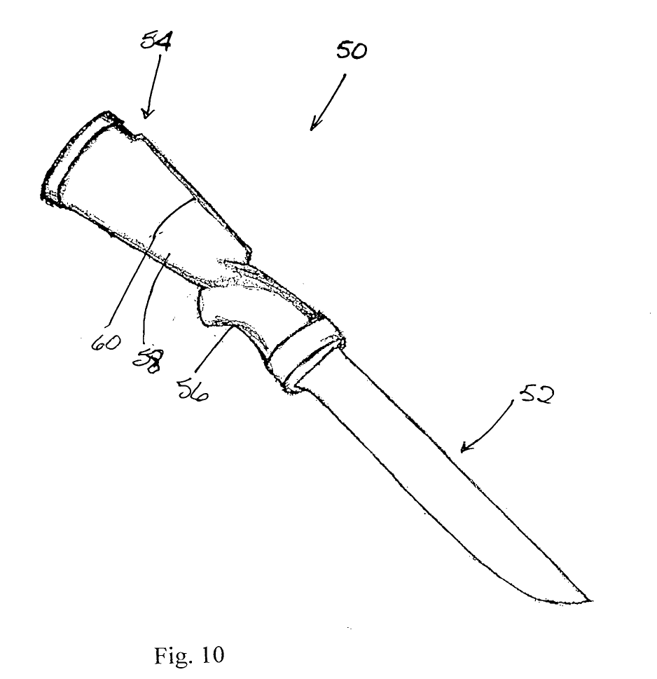

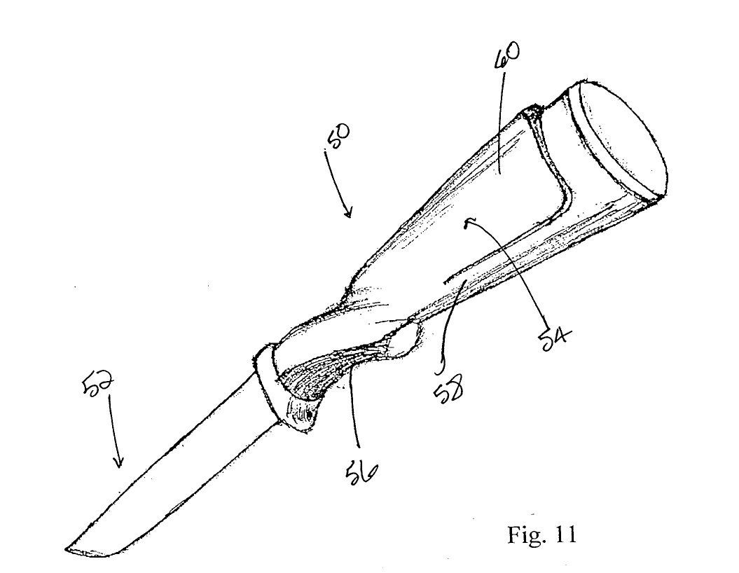

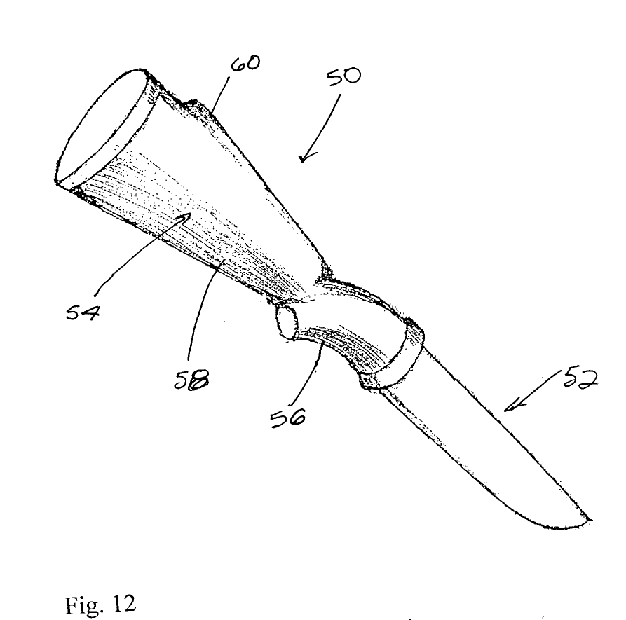

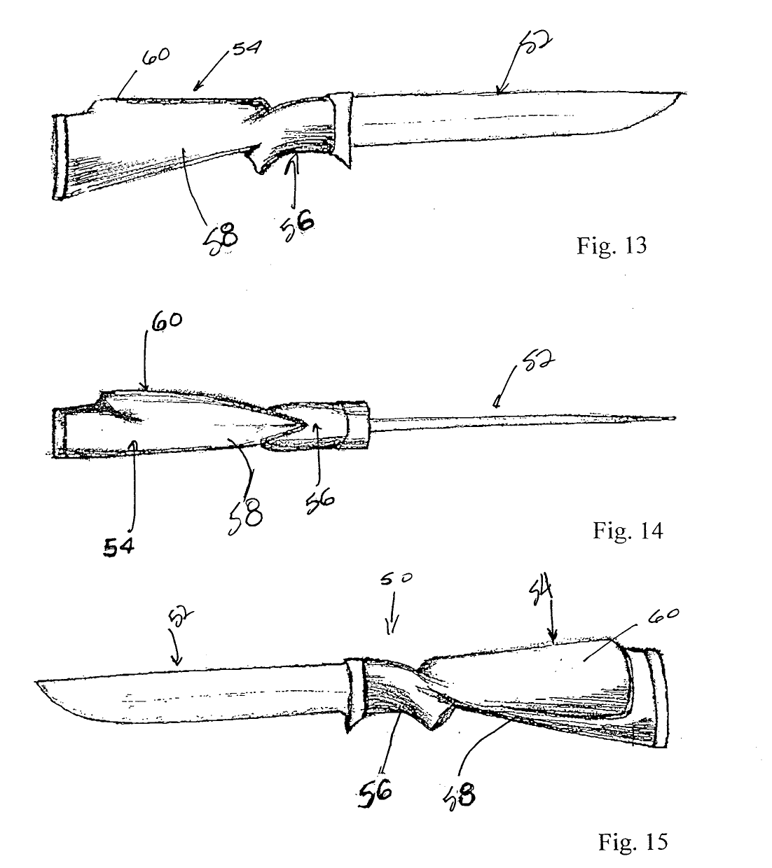

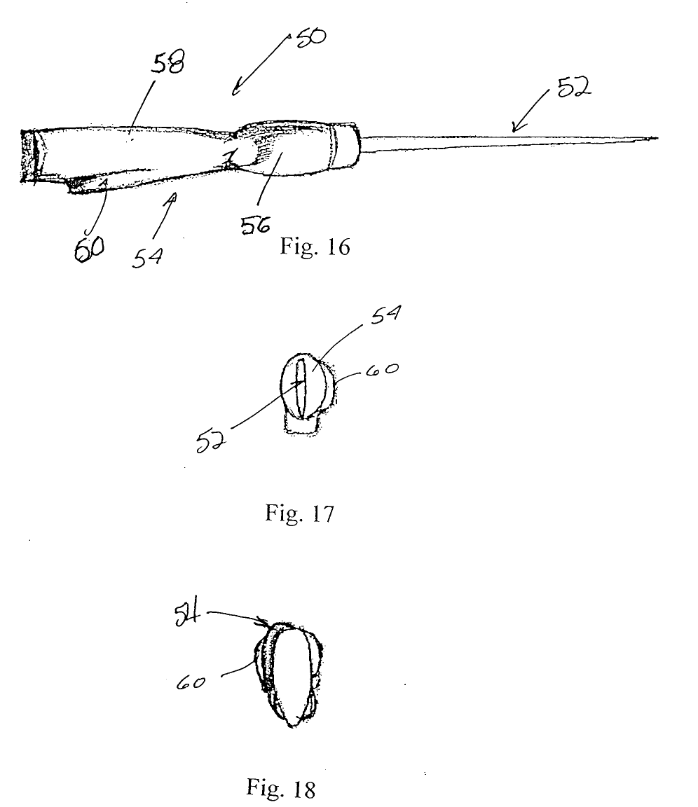

A second embodiment 50 of the hunting knife with rifle stock handle in accordance with the invention is illustrated in FIGS. 9-18. Knife 50 includes a knife blade 52 and rifle stock handle 54. Knife blade 52 can be substantially the same as blade 22 of the first embodiment. Handle 54 is similar to handle 24 except that handle 54 is formed in the shape of a rifle stock that simulates the appearance of a rifle stock of a Monte Carlo style rifle. Handle 54 has a forefinger portion 56 and a hand gripping portion 58 similar to handle 24, except that the hand gripping portion has a raised portion 60 representative of the Monte Carlo style rifle.

It should be noted that the inventive knife can be utilized by people other than hunters, such as fishermen, trappers, butchers, and military personnel.

It will be understood by one having ordinary skill in the art and by those who practice the invention that various modifications and improvements may be made without departing from the spirit of the disclosed concept. Various relational terms, including left, right, front, back, top, and bottom, for example, are used in the detailed description of the invention and in the claims only to convey relative positioning of various elements of the claimed invention. The scope of protection afforded is to b determined by the claims and by the breadth of interpretation allowed by law.

I claim:

1. A hunting knife comprising an elongated blade and attached handle, the blade having a longitudinal axis, the blade having a sharpened edge along a longitudinal side and having a sharpened tip at an outer end and a handle mounting portion at an inner end, the handle being mounted on the handle mounting portion, the handle being formed in the shape of a portion of a rifle stock, the handle having a generally straight longitudinal axis that is generally parallel to the axis of the blade, the portion of the rifle stock represented in the knife handle including only a trigger hand and a shoulder engaging portion, the shoulder engaging portion extending from the trigger hand portion to a rear end of the handle, the portion of the handle representing the trigger hand portion of the rifle stock serving as a forefinger portion of the handle and being shaped so as to comfortably engage a forefinger of a person holding the knife, a hand gripping portion of the handle representing the shoulder engaging portion of the rifle stock and being shaped to comfortably engage the hand and fingers other than the forefinger of the person holding the knife.

2. A hunting knife according to claim 1 wherein the forefinger portion of the handle is curved gradually downwardly for a distance sufficient to accommodate a typical user's forefinger, the hand gripping portion extending rearwardly from the forefinger portion and having a generally oval shape that is sufficiently large to present a comfortable hand grip.

3. A hunting knife according to claim 2 wherein the hand gripping portion flares laterally outwardly toward the rear end of the handle so as to restrain the hand of the user from slipping off the rear end of the handle.

4. A hunting knife according to claim 3 wherein the handle includes a laterally protruding projection at the junction between the forefinger portion and the hand gripping portion, such that the hand gripping portion engages the laterally protruding projection and is restrained from sliding forwardly on the handle toward the sharpened edge of the blade when the knife is forced forwardly against a resisting force.

5. A hunting knife according to claim 4 wherein the laterally protruding projection is formed by a rear outer end of the forefinger portion of the handle, the laterally protruding projection being formed in the shape of the bottom of the trigger hand portion of the rifle stock adjacent where the trigger hand portion joins the shoulder engaging portion.

6. A hunting knife according to claim 1 wherein the handle is formed in the shape of a rifle stock that simulates the appearance of a rifle stock of a rifle known as a Monte Carlo style rifle.

7. A hunting knife according to claim 1 wherein the handle is formed in the shape of a rifle stock that simulates the appearance of a rifle stock of a rifle known as a Winchester style rifle.
